(19) United States
(12) Patent Application Publication
(10) Pub. No.: US 2019/0316620 A1
(43) Pub. Date: Oct. 17, 2019

(54) MALE PIN AND FEMALE HOUSING SET FOR A DISPLAY STAND, WITH A QUICK-ENGAGEMENT ATTACHMENT SYSTEM

(71) Applicant: Chung KWO TZUO, São Paulo (BR)

(72) Inventor: Chung KWO TZUO, São Paulo (BR)

(21) Appl. No.: 16/466,595

(22) PCT Filed: Mar. 22, 2017
(86) PCT No.: PCT/BR2017/050068

§ 371 Date: Jun. 4, 2019

(51) Int. Cl. F16B 12/12; A47F 5/11

(52) U.S. Cl. CPC F16B 12/12; A47F 5/11

(57) ABSTRACT

A male pin attaches on lateral edges of shelves and respective female housings on lateral walls of display stands after gluing the shelves and lateral walls. The male pin and its coupling end have hinged rear flaps securable to each other by coupling pegs and recesses, and with coupling lugs and cradles. The female housing has a front track that incorporates a rear clip. The male pin and female housing are secured, respectively, in indentations near ends of front shelf edges and in indentations in lateral walls. For assembly, the pegs/recesses and lug/cradle of the male pin insert in the indentation, for securing by quick engagement at both ends of the front edge of the shelf and laterally exposing the coupling end. The female housing inserts by its rear clip in the lateral wall indentation, positioning the front track thereof to receive the coupling end of the male pin.

The present specification relates to an invention patent application for constructive adaptations performed on both the male pin for fastening in recesses near the extremities of the front edge of the shelf, and the female housing for fastening in recesses in the lateral walls of the display stand, thus obtaining an unprecedented quick-engagement attachment system for these elements.

According to the project, the male pin comprises two rear hinged flaps incorporated in its coupling end, featuring opposing inner surfaces bearing coupling pegs and coinciding recesses along with coupling lugs and coinciding cradles. Said rear flaps are hinged so as to allow locking between the pegs and recesses and also the lugs and cradles that couple together between the recesses at the extremities of the frontal edge of the shelf, positioning the male pin at the external lateral corner, leaving its coupling end exposed. With such a structure, it is possible to manually or automatically glue the shelf, and thus the male pin can be inserted at a subsequent stage, upon the assembly of the display stand.

The female housing, in turn, bears a front track incorporating a rear clip. By means of this rear clip, the female housing is simply inserted into a recess in the lateral wall of the display. With such a structure, it is possible to glue the lateral wall manually or automatically, and thus the female housing can also be inserted at a subsequent stage, also upon the assembly of the display stand. Via its rear clip, the female housing can be simply inserted into recesses in solid walls and tubular columns, or points which are hard to reach in other types of display stand.

Furthermore, the pins and female housings can be carried separately from the cardboard material during the transport of the display to its point of use.

### STATE OF THE ART

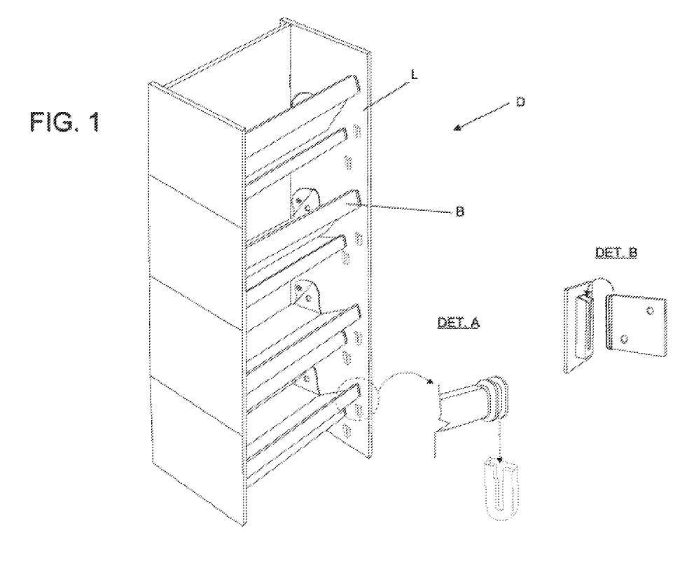

A type of product display stand that is well-known and widely used is the stand protected by document PI 1104563-9, filed on Sep. 2, 2011 and entitled “SET OF COUPLING PINS FOR LOCKING SYSTEM WITH HORIZONTAL ADJUSTMENT OF THE SHELVES, IN DISPLAY STAND” This display stand has been protected by the same inventor of the application to be disclosed below. Said cardboard display stand of PI 1104563-9, as explained in its content, features at the inner surface of its two lateral walls, plastic female housings (comprising a flat side and track) perfectly aligned for the coupling of the corresponding plastic male pins (comprising a flat side and coupling peg), attached in turn to the lateral edges, externally to the shelves. When assembling the display stand at the sales outlet the shelves are hinged at the rear wall and, when lowered, the coupling pegs of the male pins couple with the tracks on the female housings on the lateral walls. In this way, the shelves are locked horizontally to receive the products to be displayed. This locking system may be seen in FIG. 1 and its details A and B, drawings included by way of example in this new patent application, having been taken from the aforementioned document PI 1104569-9.

Currently, for the attachment of the female housing, in the cutting and creasing project, the execution of holes is foreseen in the closing flap that hinges over the lateral wall of the stand. Thus, after the flat display stand leaves the cutting and creasing machine, the closing of the lateral wall may be performed manually when, at the production line, the operator applies glue to the inner surface of the lateral wall. Next, the female housing is inserted by its track into the hole in the closing flap and is in turn adjusted so that the flat side of said female housing settles against the inner surface of the lateral wall which will, together with another sheet, be glued to form a double sheet. In this way, the lateral double-thickness walls of the display stand, whereon the tracks of the female housings are exposed, are formed.

At the same production line, the operator applies glue manually over the inner surface of the front edge of the shelf and also over the inner surface of its frontal closing flap. Next, on this inner surface of the front edge of the shelf, the flat side of the male pin is seated and then fixed by the curing of the glue, maintaining its position in such a way that its coupling peg is exposed externally and laterally, thus hinging the aforementioned frontal closing flap. In this way, the front edge of the shelf is assembled, with a double-thickness sheet and the coupling studs of the male pins left exposed externally and laterally so as to coincide with the tracks of the female housings on the lateral walls of the display stand.

As may be seen, manual stages are required for the application of glue, the seating and adjustment of the female housing for the passage of its track through the hole, its articulation and the curing time for the definitive attachment of the flat side of the male pin and even the closing of the flaps to form the double-thickness sheets for both the lateral walls and the shelves.

In the case of automatic gluing of the lateral walls and of the shelves, the closing is performed by the passage of glue rollers between the double sheets along a work surface. In this system, both the male pin and the female housing must be affixed later, likewise requiring precise recesses and measurements in the assembly stage of the display structure.

Evidently, procedures such as the manual or automatic gluing of the walls and shelves require time and some skill from the operator to make them more agile, even bringing additional stages to the process, which might lead to marking errors in the correct location of the female housing and male pin, adversely affecting the display stand production line.

### OBJECTIVE OF THE PATENT

The project in question, the reason for this patent application, relates to the construction and attachment system of both the male pin and the female housing. The project enables either the manual or the automatic gluing of these parts of the display stand (shelves and walls) without the male pin and the female housing, expediting that stage of the production line. After this manual or automatic gluing stage, only when the display structure is assembled will the male pin and the female housing will be affixed to the recesses at the extremities of the frontal edge of the shelf and into the recesses in the lateral walls of the display stand, respectively.

The female housing may also be inserted by its clip in solid display walls, in tubular columns or points whose access is difficult.

As an additional advantage, the display can be transported flat, stacked, without the pins or female housings, which can be accommodated separately. As a result, the stacking is less high (more units can be stacked) and there is no problem with unwanted creases due to the weight resting on the female housings, which end up marking the cardboard forming the display stand.

Having been explained briefly, the male pin and female housing will now be described in greater detail.

FIG. 1 portrays a display stand such as that mentioned in the state of the art, revealing in details A and B the female housings on the lateral walls with which the male pins on the shelf align.

The following figures, from 2 to 7, relate to the construction and the system of the male pin and female housing set, as well as their affixing systems:

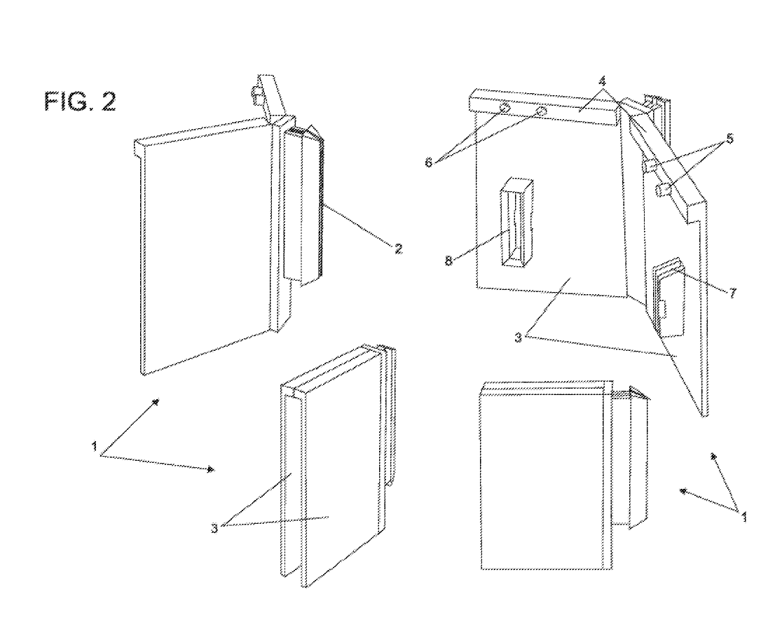

FIG. 2—portrays perspective views of the male pin, shown from its coupling end and rear hinged flaps while open, prior to locking, and also with the rear flaps closed, in the post-locking position;

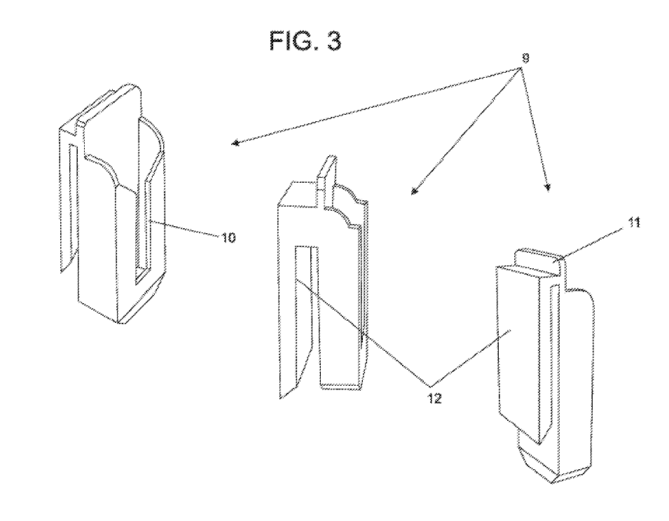

FIG. 3—portrays perspective front, side and rear views of the female housing, showing that a rear clip is incorporated on its flat side;

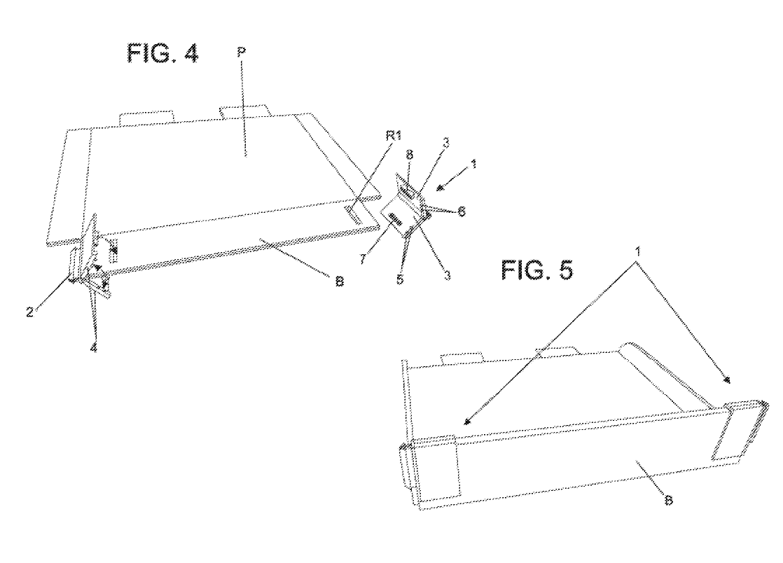

FIG. 4—portrays a perspective view, showing the male pin and its flaps in a position for its locking into the recesses at the extremities of the frontal edge of the shelf. As can be seen from the indicative arrows, the coupling pegs are aligned with the cavities while the lugs are aligned with the cradles, passing through the recesses at the extremities of the front edge of the shelf;

FIG. 5—portrays a view as in the previous figure, showing that after the closure of the flaps, the male pins are locked with their coupling ends positioned externally and laterally at the frontal edge of the shelf;

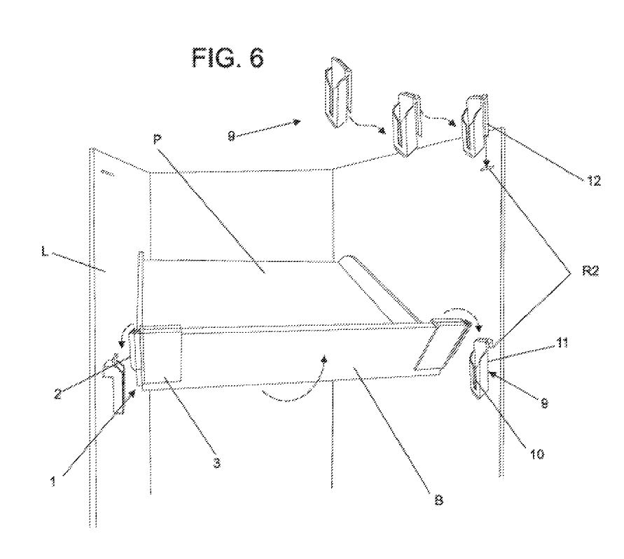

FIG. 6—portrays a partial perspective view of one tier of the display stand, as used at a sales outlet. As may be seen, the clips of the female housings are lodged in the recesses in the lateral walls of the display stand, locating their tracks to engage the coupling ends of the male pins attached to the shelves.

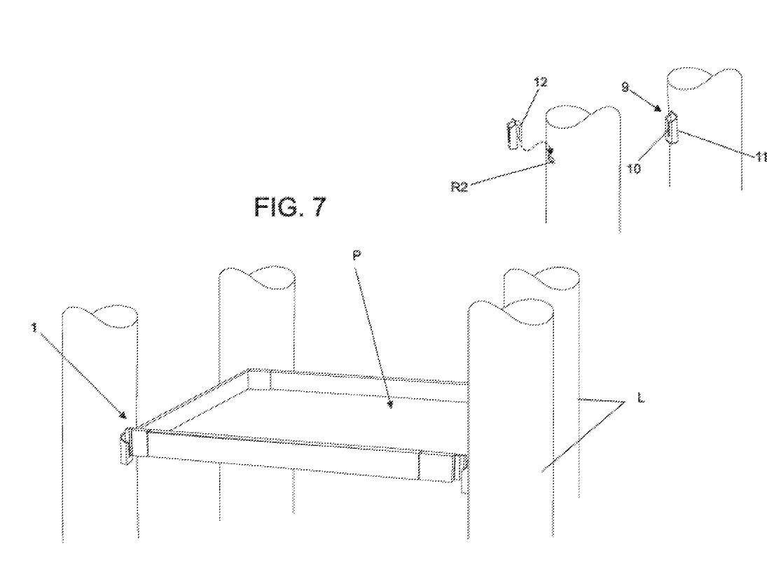

FIG. 7—portrays a perspective view of the female housing being used with the tubular columns of a display stand. As may be seen from the sequence shown at the top of the page, it merely requires the execution of a slot for the insertion of the clip of the female housing. The same is true in hard-to-reach points of other types of display stand.

In accordance with the attached drawings, the “MALE PIN AND FEMALE HOUSING SET FOR A DISPLAY STAND, WITH A QUICK-ENGAGEMENT ATTACHMENT SYSTEM” which is the object of the present invention patent application consists of an assembly especially developed for its application in display stands (D) of the type portrayed in FIG. 1 of the state of the art, said assembly comprising a male pin (1) with a coupling end (2) in accordance with the new project, incorporating two rear hinged flaps (3) featuring on their inner surfaces, upper swinging sections (4) with studs (5) coinciding with coupling cavities (6), and also lugs (7) coinciding with coupling cradles (8) as shown in the sequence in FIG. 2. The male pin (1) acts with a female housing (9) featuring a frontal track (10) incorporating, on its flat side (11), a rear clip (12), as shown in the sequence in FIG. 3.

The set of male pin (1) and female housing (9) being thus constituted, they are fixed in the recesses (R1) near the extremities of the frontal edges (B) of the shelves (P) and in the recesses (R2) in the lateral walls (L) of display stands (D) respectively, subsequent to the manual or automatic gluing stage (performed with conventional equipment). For their application, during the assembly stage of the display stand (D), as shown in FIG. 4, the flaps (3) are aligned with the recess (R1) in the front edge (B) of the shelf (P) thus being articulated in such a way as to enable the simultaneous coupling by pressure of the studs (5) and cavities (6) and of the lugs (7) and cradle (8) subsequent to the passage of these elements through the aforementioned recess (R1), being locked by means of a quick-engagement system in a procedure performed at both sides of the frontal edge (B) of the shelf (P). As shown in FIG. 5, after the quick engagement, the lateral extremities of the front edge (B) of the shelf (P) have the coupling ends (2) of the male pins (1) positioned externally.

For the attachment of the female housing (9), as shown in FIG. 6, it is simply inserted into the recess (R2) in the lateral wall (L) by means of its rear clip (12). With the mere insertion of several units, the flat sides (11) of the female housings (9) rest against the inner surfaces along the two lateral walls (L) for the positioning of their frontal tracks (10), which will house the coupling ends (2) of the corresponding male pins (1) on the shelves (P). Due to its simple insertion, by means of its rear clip (12), the female housing (9) may be attached to the solid cardboard walls of display stands or critical points of display stands of other types, such as cut-outs (R2) in tubular columns, as shown in the sequence in FIG. 7, likewise positioning its frontal tracks (10) to house the coupling ends (2) of the male pins (1) on the shelves (P).

1. A male pin and female housing set for display stands, comprising a male pin with a coupling end, two rear hinged flaps including on inner surfaces, upper swinging sections with studs aligning with coupling cavities, and lugs aligning with a coupling cradle; said male pin being complemented with a female housing featuring a frontal track and incorporating a rear clip on a flat side.

2. A quick engagement attachment system comprising the set as claimed in claim 1, wherein the assembly stage of the display stand comprises alignment of the rear hinged flaps of the male pin and a recess at an extremity of a frontal edge of a shelf, followed by simultaneous closure under pressure of the coupling between studs and cavities and of the lug and cradle, locked through the recess, fastening respective pairs of male pins by the coupling ends positioned externally, on both sides of the frontal edge of the shelf, the rear clips of corresponding pairs of female housings are inserted into recesses in lateral walls of the display stand, exposing frontal tracks on a level with the coupling ends of the pairs of male pins.

3. The male pin and female housing set as claimed in claim 1, wherein coupling of the male pin and female housing at the extremities of the frontal edges of the shelves and on the lateral walls respectively occurs only subsequent to a manual or automatic gluing stage of sections of the display stand.

4. The quick engagement attachment system as claimed in claim 2, wherein coupling of the male pin and female housing at the extremities of the frontal edges of the shelves and on the lateral walls respectively occurs only subsequent to a manual or automatic gluing stage of sections of the display stand.
